(19) United States
(12) Patent Application Publication
(10) Pub. No.: US 2015/0184552 A1
(43) Pub. Date: Jul. 2, 2015

(54) CONTROLLING APPARATUS AND STARTING METHOD

(71) Applicant: Kabushiki Kaisha Toshiba, Minato-ku (JP)

(72) Inventors: Masayuki TOBO, Kawasaki (JP); Takahiro MORI, Yokohama (JP); Kazuna SAWATA, Yokohama (JP)

(73) Assignee: Kabushiki Kaisha Toshiba, Minato-ku (JP)

(21) Appl. No.: 14/574,520

(22) Filed: Dec. 18, 2014

(30) Foreign Application Priority Data
Dec. 26, 2013 (JP) 2013-270029

(51) Int. Cl. F01K 23/10; F02C 7/26

(52) U.S. Cl. CPC F01K 23/101; F02C 7/26; F05D 2220/32; F05D 2220/72; F05D 2270/13

(57) ABSTRACT

According to one embodiment, a controlling apparatus is a controlling apparatus for a combined cycle power-generating plant having a plurality of power-generating plants, each of the power-generating plants comprising: a power generator; a gas turbine that is connected with the power generator; and an heat recovering steam generator that recovers heat of exhaust gas from the gas turbine and generates steam from an incorporated drum. The controlling apparatus comprises a controlling unit that controls the turbine bypass regulating valve. The controlling unit closes the turbine bypass regulating valve in accordance with a predetermined time-dependent change, before the controlling valve is in a full open state. The controlling unit controls the turbine bypass regulating valve based on a pressure of the drum of the power-generating plant subsequently started, when the controlling valve is in the full open state.

### CROSS-REFERENCE TO RELATED APPLICATIONS

This application is based upon and claims the benefit of priority from Japanese Patent Application No. 2013-270029, filed Dec. 26, 2013; the entire contents of which are incorporated herein by reference.

### FIELD

Embodiments described herein relate generally to a controlling apparatus and a starting method.

### BACKGROUND

As combined cycle power-generating plants that are configured by the combination of a gas turbine plant, an heat recovering steam generator (HRSG: Heat Recovery Steam Generator) and a steam turbine plant, some schemes are known. For example, a combined cycle power-generating plant in which two gas turbines, two heat recovering steam generators and one steam turbine are combined is called a 2-2-1 (two-two-one) scheme. In the 2-2-1 scheme, a power-generating plant including one gas turbine, one power generator and one heat recovering steam generator is called a first unit. Further, a power-generating plant including the other gas turbine, the other power generator and the other heat recovering steam generator is called a second unit.

The heat recovering steam generator of the first unit recovers the heat of the gas turbine exhaust gas, and steam is generated from an incorporated drum. The steam is supplied to the steam turbine through a controlling valve, as turbine driving steam, and the steam turbine is driven. On this occasion, for example, a so-called preceding pressure control is applied to the controlling valve. This controls the steam amount to be flowed in the steam turbine, so as to keep the preceding pressure (the main steam pressure at the upstream part of the steam controlling valve) constant. Thereby, the pressure in the drum of the heat recovering steam generator is kept proper, and therewith, the turbine output is regulated corresponding to the increase and decrease in the generated steam amount.

A conventional combined cycle power-generating plant firstly (antecedently) starts the first unit, and then starts the steam turbine by the steam generated in the first unit. Thereafter, the second unit is started, and the steam generated in the second unit is gradually inserted in the turbine driving steam. A turbine bypass regulating valve of the second unit, which regulates the insertion steam, is controlled by a feedback control in which the valve opening degree is reduced in several steps.

A case in which the feedback pressure control performed until then by the turbine bypass regulating valve of the second unit is continued even after the valve opening of an isolation valve provided between the drum of the second unit and the controlling valve is discussed. In this case, this steam system (that is, the whole of the first unit, second unit and steam turbine that are linked) operates the pressure controls of two lines: the preceding pressure control of the controlling valve and the pressure control of the turbine bypass regulating valve of the second unit, independently and in parallel. Therefore, for example, there is a probability that, when the preceding pressure control of the controlling valve raises the pressure in the second drum, the pressure control of the turbine bypass regulating valve of the second unit, on the contrary, lowers the pressure in the drum. Thus, there is an interference problem of the pressure controls between both valves.

Because of this interference problem, it is possible that the interference is avoided by stopping the feedback pressure control of the turbine bypass regulating valve in association with the valve opening of the isolation valve, and instead, switching to a controlling scheme in which the control command value of the control unit is set to the valve closing command value and the turbine bypass regulating valve is forcibly closed at a predetermined changing rate (this is called a forcible valve closing, for example), such that only one line of the preceding pressure control of the controlling valve performs the pressure control of the steam system.

However, even when such an avoidance is performed, in the case where the controlling valve is fully opened before the turbine bypass regulating valve is fully closed, the insertion steam is not absorbed and the pressure of the steam header unit rises, if the forcible valve closing is pursued and the insertion of the steam is continued even after the full opening of the controlling valve. This pressure rise continues during the period after the controlling valve is fully opened and before the turbine bypass regulating valve of the second unit is fully closed. The pressure rise of the steam header unit in this period results in a random rise in the inside pressures of the drum of the first unit and the drum of the second unit, which are directly linked with it. This means that the function to keep the pressures in the drum of the first unit and the drum of the second unit appropriate, which is played by the preceding pressure control until then, has been lost. In this case, a sudden pressure rise can result in a drastic drop in the drum water level, and can lead to an emergency stop of the heat recovering steam generators. Thus, in the case where the controlling valve is fully opened before the turbine bypass regulating valve of the second unit is fully closed, there is a problem in that the stability of the operation of the first unit and second unit decreases by the subsequent insertion of the insertion steam.

### BRIEF DESCRIPTION OF THE DRAWINGS

FIG. 1 is a schematic configuration diagram showing the configuration of a 2-2-1 scheme multi-axial combined cycle power-generating plant according to the embodiment and a controlling apparatus.

FIG. 2 is a starting chart showing a starting method for the multi-axial combined cycle power-generating plant according to the embodiment.

FIG. 3 is a schematic configuration diagram showing a second modification of the multi-axial combined cycle power-generating plant and the configuration of a controlling apparatus 300b.

FIG. 4 is a schematic configuration diagram showing a third modification of the multi-axial combined cycle power-generating plant and the configuration of a controlling apparatus 300b.

FIG. 5 is a configuration example of a 2-2-1 multi-axial combined cycle power-generating plant according to a comparative example.

FIG. 6 is a starting chart of the plant according to the comparative example.

FIG. 7 is a comparative example of a starting chart in the case where the controlling valve 401 is fully opened before the #2 turbine bypass regulating valve 201 is fully closed.

### DETAILED DESCRIPTION

According to one embodiment, a controlling apparatus is a controlling apparatus for a combined cycle power-generating plant having a plurality of power-generating plants, each of the power-generating plants comprising: a power generator; a gas turbine that is connected with the power generator; and an heat recovering steam generator that recovers heat of exhaust gas from the gas turbine and generates steam from an incorporated drum, the combined cycle power-generating plant being started when generated steam from at least one power-generating plant antecedently started passes through a controlling valve and is supplied to a steam turbine, as turbine driving steam, and generated steam from one power-generating plant subsequently started is inserted into an upstream part of the controlling valve, as insertion steam to the turbine driving steam, depending on an opening degree of a turbine bypass regulating valve that is connected with the power-generating plant subsequently started. The controlling apparatus comprises a controlling unit that controls the turbine bypass regulating valve. The controlling unit closes the turbine bypass regulating valve in accordance with a predetermined time-dependent change, before the controlling valve is in a full open state. The controlling unit controls the turbine bypass regulating valve based on a pressure of the drum of the power-generating plant subsequently started, when the controlling valve is in the full open state.

### Controlling Apparatus According to Comparative Example

Before the explanation of a controlling apparatus according to the embodiment, a controlling apparatus according to a comparative example will be explained, and the problem of the embodiment will be explained.

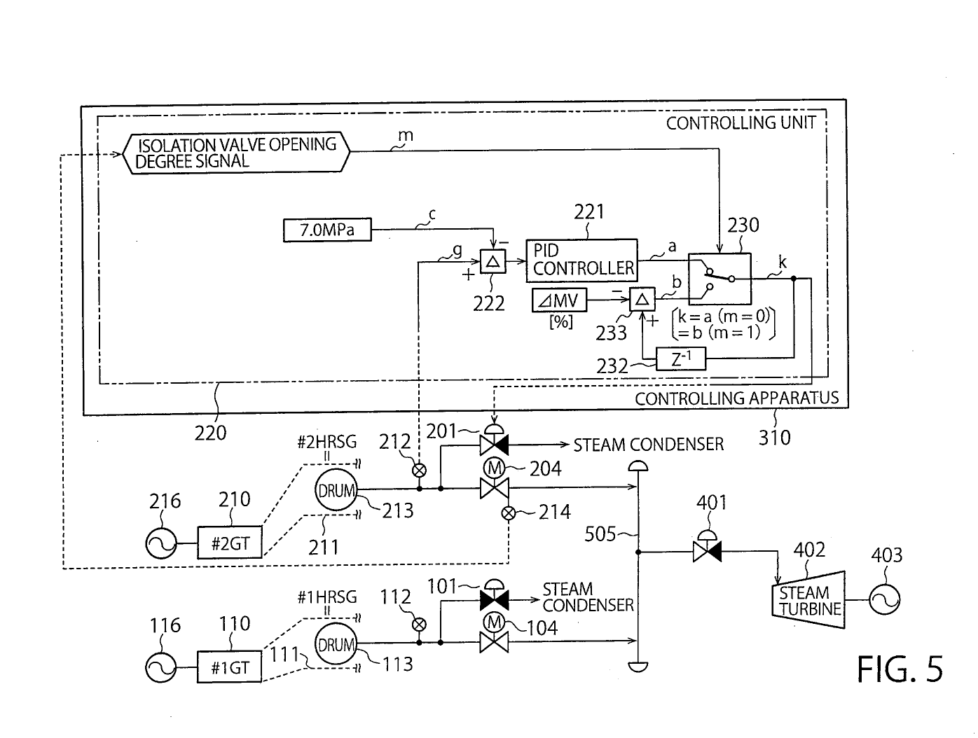

FIG. 5 is a configuration example of a 2-2-1 multi-axial combined cycle power-generating plant according to a comparative example. This is called a 2-2-1 (two-two-one) scheme, because two gas turbines, two heat recovering steam generators and one steam turbine are combined.

Here, for convenience, a power-generating plant including a #1 gas turbine 110, a #1 power generator 116 and a #1 heat recovering steam generator 111, which is one of two configurations in the 2-2-1 scheme, is collectively referred to as a #1 unit. Further, the other power-generating plant including a #2 gas turbine 210, a #2 power generator 216 and a #2 heat recovering steam generator 211 is referred to as a #2 unit. In the figure, a steam turbine 402 and a power generator 403 are illustrated. These are common equipment between the #1 unit and the #2 unit, and do not belong to the #1 unit or the #2 unit.

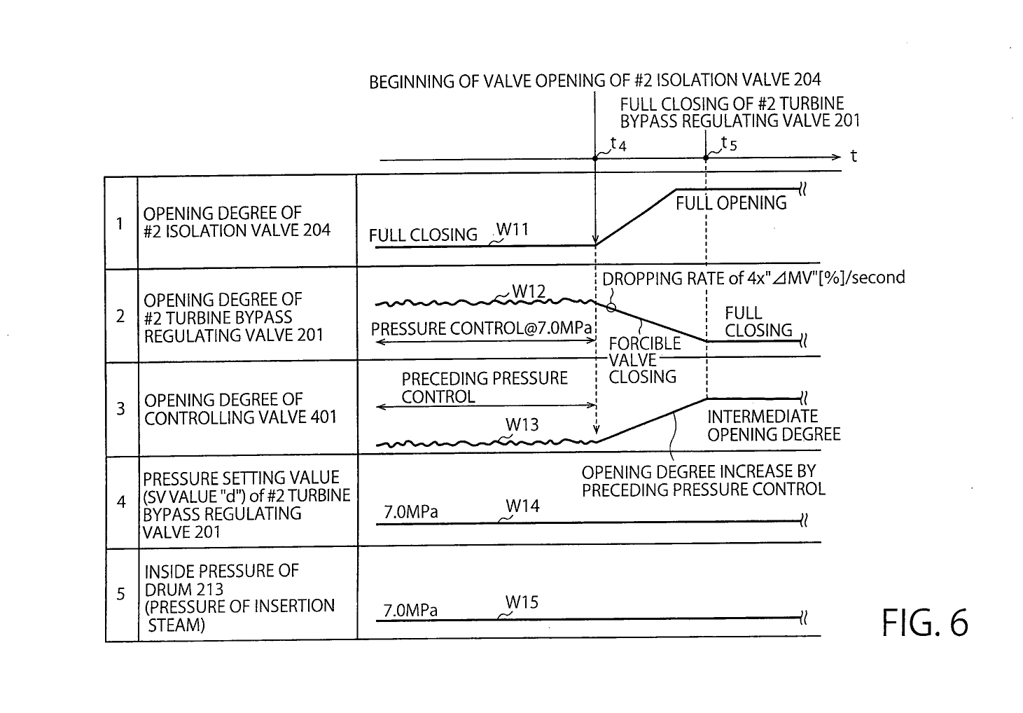

Furthermore, as shown in FIG. 5, a controlling apparatus 310 includes a controlling unit 220. The controlling unit 220 executes, for example, the software stored in a storing unit not shown in the figure, and thereby, controls a #2 turbine bypass regulating valve 201. FIG. 6 is a starting chart of the plant according to the comparative example. FIG. 6 illustrates how the controlling unit 220 acts along the plant starting.

As a starting method for the multi-axial combined cycle power-generating plant, firstly (antecedently), the #1 unit is started, and by the steam generated by the #1 unit (the generated steam from the #1 unit is referred to as “turbine driving steam”), the steam turbine 402 is started. Thereafter, the #2 unit is started, and the steam generated by the #2 unit (hereinafter, the steam generated from the #2 unit is referred to as “insertion steam”) is gradually inserted in the turbine driving steam.

To describe this in detail, in FIG. 5, the antecedent #1 gas turbine 110 is operating, the #1 heat recovering steam generator 111 recovers the heat of the gas turbine exhaust gas, and steam is generated in an incorporated #1 drum 113. This steam is supplied to the steam turbine 402 through a controlling valve 401, as the turbine driving steam, and the steam turbine 402 is driven. On this occasion, a so-called preceding pressure control is applied to the controlling valve 401.

In this preceding pressure control, the steam amount to be flowed in the steam turbine is controlled such that the preceding pressure (the main steam pressure at the upstream part of the steam controlling valve) is kept constant. Thereby, the pressure in the drum of the boiler, and the like are kept proper, and therewith, the turbine output is regulated corresponding to the increase and decrease in the generated steam amount. This is applied mainly to the case of using a boiler in which a rapid control of the generated steam amount is impossible (or difficult), and is often combined with a speed governing apparatus.

For example, in the preceding pressure control (the control circuit is not shown in the figure) of the controlling valve 401 in FIG. 5, the amount of the turbine driving steam to be flowed in the steam turbine 401 is controlled such that the steam pressure of the steam header unit 505 (the pressure at the upstream part of the controlling valve 401, that is, this is the preceding pressure) is kept at 7.0 MPa constantly. Thereby, the pressure of the #1 drum 113 of the #1 heat recovering steam generator 111 is kept at 7.0 MPa (more accurately, “7.0 MPa+ε” in which a pipe pressure loss amount “ε” is added). Here, the controlling circuit to control the controlling valve 401, which is not shown in the figure, may be included in a controlling apparatus other than the controlling apparatus 310, or may be included in the controlling apparatus 310.

Here, in the example of FIG. 5, a #1 turbine bypass regulating valve 101 is in a state in which it is fully closed, the #2 turbine bypass regulating valve 201 is in a state of an intermediate opening degree, a #1 isolation valve 104 and a #2 isolation valve 204 are in a state in which they are fully opened, and the controlling valve 401 is in a state of an intermediate opening degree. Further, all the numerical values used in the specification are examples considering convenience for explanation.

On the other hand, the subsequent #2 gas turbine 210 and #2 heat recovering steam generator 211 are also started. However, shortly after the starting, the pressure and temperature of the insertion steam are insufficient, and this is not suitable for the insertion steam for starting. In this period, the #2 isolation valve 204 (for example, the isolation valve is a shut-off valve that is a motor-operated valve) is put into a full close state, and the generated steam of the #2 unit is not flowed in the steam turbine 402. Instead, the #2 turbine bypass regulating valve 201 is opened by the controlling unit 220, and the operation is performed such that the generated steam from the #2 drum 213 is released to a steam condenser not shown in the figure, while the pressure is controlled so as to be kept at 7.0 MPa.

In the period for which the #2 isolation valve 204 is fully closed, the operation is performed in this way. On the other hand, after the starting of the #2 gas turbine 210, the pressure and temperature of the insertion steam increase and rise as time passes. When they get to be suitable values for starting, the valve opening operation of the #2 isolation valve 204 is gradually performed, the “linking” of the #2 unit to the #1 unit and the steam turbine 402 is performed, and the “insertion” begins.

FIG. 6 is a starting chart of the plant according to the comparative example. FIG. 6 illustrates a waveform W11 showing a temporal change in the opening degree of the #2 isolation valve 204, a waveform W12 showing the opening degree of the #2 turbine bypass regulating valve 201, a waveform W13 showing the opening degree of the controlling valve 401, a waveform W14 showing the pressure setting value (SV value “d”) of the #2 turbine bypass regulating valve 201, and a waveform W15 showing the inside pressure of the #2 drum 213 (the pressure of the insertion steam).

As shown by the waveform W12 at times “t₄” to “t₅” in FIG. 6, simultaneously with the beginning of the valve opening of the #2 isolation valve 204, the controlling unit 220 closes the #2 turbine bypass regulating valve 201 at a predetermined changing rate, and then, fully closes it at time “t₅”.

By this action, the insertion steam, which was being flowed in the steam condenser until then, is sent to the steam header unit 505. This sending raises the pressure of the steam header unit 505 to 7.0 MPa or more (microscopically speaking). In the action of the preceding pressure control of the controlling valve 401 described above, the pressure rise of the steam header unit 505 is detected, and the opening degree of the controlling valve 401 is increased. In other words, the steam turbine 402 absorbs the insertion steam, and thereby, the pressure falls. Then, the steam header unit 505 is restored to the pressure of 7.0 MPa.

In such a procedure, the insertion steam from the #2 unit is inserted in the turbine driving steam, and when the #2 turbine bypass regulating valve 201 is fully closed (at time “t”=“t₅”, in FIG. 6), the whole amount of the insertion steam from the #2 unit joins the turbine driving steam, and the steam turbine 402 is driven.

Thereafter, although not shown in FIG. 6, the load-up is performed such that the #1 gas turbine 110 and the #2 gas turbine 210 reach 100% of the rated output. A large amount of generated steam from the #1/#2 units associated with it increases the opening degree of the controlling valve 401, by the action of the preceding pressure control similar to the above, and finally, the controlling valve 401 is fully opened.

### Configuration of Controlling Unit 220

Here, the configuration of the controlling unit 220 in FIG. 5 is explained. For convenience of explanation, the controlling apparatus 310 in FIG. 5 employs a digital computing scheme in which the computation is performed in a sampling period of 250 milliseconds, as an example, and in the interior, the controlling unit 220 is programmed as software.

As for the working principle of a PID controller 221 incorporated in the controlling unit 220, this is a controller to which a setting value (SV value) and a process value (PV value) are input and that calculates a control command value (MV value) by a feedback control such that the PV value is equal to the SV value.

In the figure, the SV value “c” is 7.0 MPa, and the #2 turbine bypass regulating valve 201 performs the pressure control such that the inside pressure of the #2 drum 213 is kept at 7.0 MPa. Further, the PV value “g” is the pressure at the outlet of the #2 drum 213, and concretely, is a value to be measured by a sensor 212. The MV value “a” is output (through a later-described control command value “k” of the controlling unit 220) as a signal for opening and closing the #2 turbine bypass regulating valve 201.

The #2 isolation valve 204 is provided with an opening degree detector 214, which is configured such that, when the valve is opened, an isolation valve opening degree signal “m” indicating the opening degree of the #2 isolation valve 204 gets to be “1”, and thereby the controlling unit 220 detects the valve opening. Here, in the isolation valve opening degree signal “m”, which has a value of 0 or 1, 0 indicates the valve closing and 1 indicates the valve opening.

Two signals of the MV value “a” of the PID controller 221 and a valve closing command value “b” are input to a switcher 230, which is configured to select the control command value k as the output, such that the MV value “a” is selected as the control command value “k” in the case of the isolation valve opening degree signal “m”=0, and the valve closing command value “b” is selected as the control command value “k” in the case of the isolation valve opening degree “m”=1. As the valve closing command value “b”, the value resulting from subtracting “ΔMV” [%] from a one-sampling-period prior (250 milliseconds prior) control command value “k” is given by the actions of a sampling delay device 232 shown by a symbol “Z⁻1” and a subtracter 233.

For the sampling delay device 232, which outputs the one-sampling-period prior control command value “k”, the detailed explanation is omitted.

### Action of Controlling Unit 220

Next, the action of the controlling unit 220 in FIG. 5 will be explained. At a certain sampling period (time=0), the #2 isolation valve 204 is fully closed (that is, the isolation valve opening degree signal “m”=0), and at this time, as the control command value “k” of the controlling unit 220, the MV value “a” of the PID controller 221 is selected by the switcher 230, resulting in the control command value “k”=MV value “a”. That is, when the #2 isolation valve 204 is fully closed, the feedback pressure control by the PID controller 221 is performed to the #2 turbine bypass regulating valve 201.

When the #2 isolation valve 204 is opened (that is, the isolation valve opening degree signal “m”=1) at the next sampling period (time=250 milliseconds), the valve closing command value “b” is selected by the switcher 230, as the control command value “k”. As described above, the valve closing command value “b” is the value resulting from subtracting “ΔMV” [%] from the one-sampling-period prior (time=0) control command value “k”, by the actions of the sampling delay device 232 and the subtracter 233, and therefore, the control command value “k”=MV value “a”−“ΔMV” holds at time=250 milliseconds. Therefore, the #2 turbine bypass regulating valve 201 is closed by “ΔMV” [%].

Then, at the next sampling period (time=500 milliseconds), similarly, the control command value “k”=the MV value “a”−2×“ΔMV” holds. At the further next sampling period (time=750 milliseconds), the control command value “k”=MV value “a”−3×“ΔMV” holds. At the further next sampling period (time=1000 milliseconds), the control command value “k”=MV value “a”−4×“ΔMV” holds.

After the #2 isolation valve 204 is opened in this way (that is, the isolation valve opening degree signal “m”=1), the #2 turbine bypass regulating valve 201 is closed at a uniform changing rate of 4×“ΔMV”[%], for one second, that is, for four periods of the sampling period of 250 milliseconds, and such a valve closing operation is performed until the full closing.

Here, the interference problem of the pressure control in FIG. 5 is mentioned. Suppose that in the procedure of the above starting method, the feedback pressure control performed until then by the #2 turbine bypass regulating valve 201 is continued (the control command value “k”=MV value “a” is continued), even after the #2 isolation valve 204 is opened. In that case, this steam system (that is, the whole of the #1 unit, #2 unit and steam turbine that are linked) operates the pressure controls of two lines: the preceding pressure control of the controlling valve 401 and the pressure control of the #2 turbine bypass regulating valve 201, independently and in parallel.

For example, this results in occurrence of a case in which, when the preceding pressure control of the controlling valve 401 raises the pressure in the drum 213, the pressure control of the #2 turbine bypass regulating valve 201, on the contrary, lowers the pressure in the drum 213. Thus, between both valves, the interference problem of the pressure control is created.

In the comparative example, because of this interference problem, the interference is avoided by stopping the feedback pressure control of the #2 turbine bypass regulating valve 201 by the PID controller 221, in association with the valve opening of the #2 isolation valve 204, and instead, switching to a controlling scheme in which the control command value “k” of the controlling unit 220 is set to the valve closing command value “b” and the opening degree of the #2 turbine bypass regulating valve 201 is forcibly decreased at a predetermined changing rate (this is called a “forcible valve closing”, for example), such that only one line of the preceding pressure control of the controlling valve 401 performs the pressure control of the steam system.

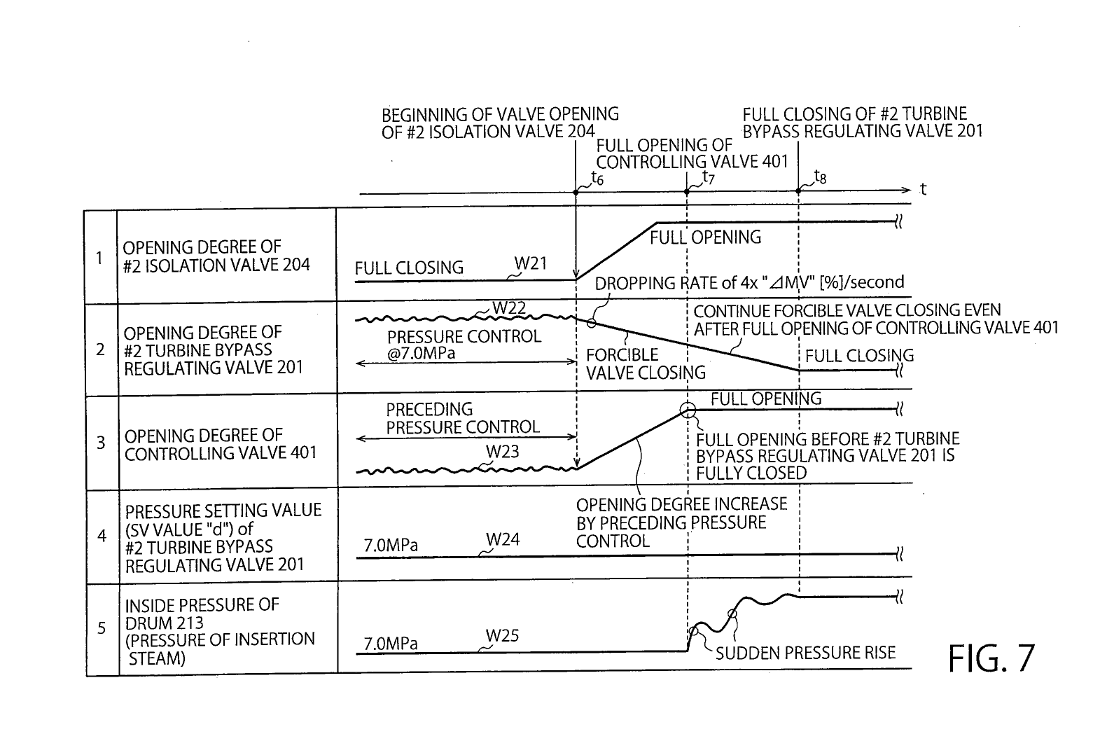

However, there is a problem in that, when the insertion steam of the #2 unit is inserted in a state in which the controlling valve 401 has a relatively large opening degree, the controlling valve 401 is fully opened halfway, and the subsequent insertion of the insertion steam is difficult. This problem of the difficulty in the insertion of the insertion steam will be explained using FIG. 7.

FIG. 7 is a comparative example of a starting chart in the case where the controlling valve 401 is fully opened before the #2 turbine bypass regulating valve 201 is fully closed. FIG. 7 illustrates a waveform W21 showing a temporal change in the opening degree of the #2 isolation valve 204, a waveform W22 showing the opening degree of the #2 turbine bypass regulating valve 201, a waveform W23 showing the opening degree of the controlling valve 401, a waveform W24 showing the pressure setting value (SV value “d”) of the #2 turbine bypass regulating valve 201, and a waveform W25 showing the inside pressure (the pressure of the insertion steam) of the #2 drum 213. The valve opening of the isolation valve 204 begins at time “t₆”, the controlling valve 401 is fully opened at time “t₇”, and the #2 turbine bypass regulating valve 201 is fully closed at time “t₈”.

Generally, in a starting from a stop in which the preservation is performed while the member metal temperature of the steam turbine 402 is a high temperature, which is called a hot starting or a very-hot starting, it is necessary, for the coordination with it, to heighten the temperature of the turbine driving steam. On that occasion, an operation in which the output of the #1 gas turbine 110 is kept relatively high and the exhaust gas temperature is heightened is selected. As a result, the amount of the turbine driving steam is great, and for consuming this, the controlling valve 401 is largely opened.

When the insertion steam from the #2 unit is inserted into the controlling valve 401 in which the clearance to the full open position is small in this way, the controlling valve 401, at first, increases the opening degree by the preceding pressure control. Thereby, as described above, the insertion steam sent to the steam header unit 505 is absorbed, and the pressure of the steam header unit 505 is kept at 7.0 MPa. However, when this is continued, the controlling valve 401 is fully opened before the #2 turbine bypass regulating valve 201 is fully closed.

When the controlling valve 401 is fully opened in this way, the opening degree cannot be increased anymore. Therefore, if the forcible valve closing of the #2 turbine bypass regulating valve 201 is pursued and the insertion of the steam is continued even after the controlling valve 401 is fully opened as shown in FIG. 7, the insertion steam is not absorbed, and the pressure of the steam header unit 505 rises. This pressure rise continues during the period after the controlling valve 401 is fully opened and before the #2 turbine bypass regulating valve 201 is fully closed. The pressure rise of the steam header unit 505 in this period results in random rises in the inside pressures of the #1 drum 113 and #2 drum 213, which are directly linked with it. This means that the function to keep the pressures in the #1 drum 113 and #2 drum 213 appropriate, which is played by the preceding pressure control until then, has been lost. In the worst case, a sudden pressure rise results in a drastic drop in the drum water level, and leads to an emergency stop of the heat recovering steam generators 111, 211. Thus, in the case where the controlling valve 401 is fully opened before the #2 turbine bypass regulating valve 201 is fully closed, there is a first problem in the embodiment, in that the stable operation of the #1 unit and #2 unit is obstructed by the subsequent insertion of the insertion steam.

Further, a second problem to be solved by the embodiment will be explained. The second problem is a disadvantage relevant to the full opening of the controlling valve 401, similarly. Although FIG. 5 shows a configuration example of the 2-2-1 multi-axial combined cycle power-generating plant, there is a case in which, for example, at the time of the failure of the #2 unit, the operation is performed by only the #1 unit and the steam turbine 401, that is, by the 1-1-1 configuration, for meeting power generation demand. Then, after the failure of the #2 unit is repaired, the #2 unit is started, and the operation as the 2-2-1 combined cycle power-generating plant is performed. This case can be regarded as a variation in which the starting of the subsequent #2 unit begins after a lapse of an extremely long time from the starting of the antecedent #1 unit, in the above-described starting method for the multi-axial combined cycle power-generating plant. Meanwhile, as a different point, since the economic efficiency as a commercial operation is looked for in a state of the 1-1-1 operation, the #1 unit is operated at 100% of the rated output, so that a large amount of turbine driving steam is generated from the #1 unit and the controlling valve 401 is fully opened. Even when the #2 unit is started in this state and the insertion of the insertion steam is attempted, this insertion is difficult for the same reason as the above.

For avoiding this, conventionally, the output fall of the #1 unit, in which the operation is performed at 100% of the rated output, is expressly performed, and the amount of the turbine driving steam of the #1 unit is decreased. Thereby, the opening degree of the controlling valve 401 is reduced from the full open state to an intermediate opening degree, and then, the insertion steam of the #2 unit is inserted. However, there is a big problem in that the output fall to a partial load, although temporarily, is performed to the power-generating plant in which the rated output operation is being performed for meeting a tight power demand.

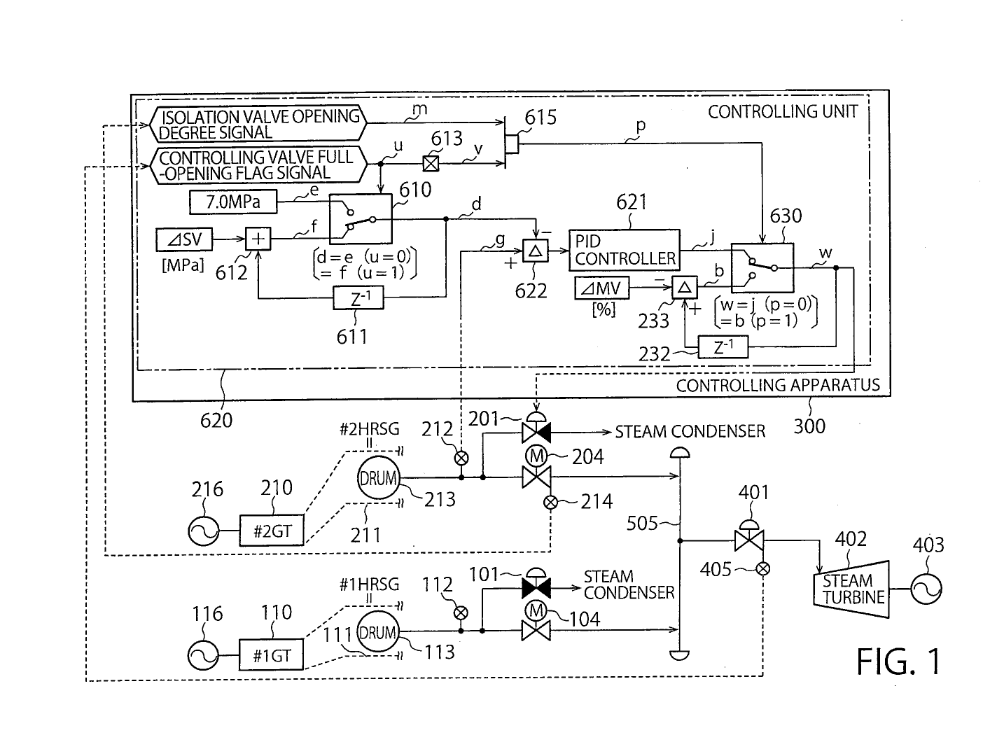

Hereinafter, the embodiment of the present invention will be explained with reference to the drawings. FIG. 1 is a schematic configuration diagram showing the configuration of a 2-2-1 scheme multi-axial combined cycle power-generating plant according to the embodiment and a controlling apparatus.

In the configuration of the 2-2-1 scheme multi-axial combined cycle power-generating plant in FIG. 1, an opening degree detector 405 is added, compared to the configuration of the 2-2-1 scheme multi-axial combined cycle power-generating plant in FIG. 5.

Here, in the embodiment, for simplification of explanation, a 2-2-1 scheme multi-axial combined cycle power-generating plant will be explained as an example. Here, the application to not only the 2-2-1 scheme but also a 3-3-1 scheme in which three gas turbines, three heat recovering steam generators and one steam turbine are combined is possible. Furthermore, the application to an N-N-1 configured by gas turbines and heat recovering steam generators whose numbers are N, which is three or more, is also possible. The opening degree detector 405, which is provided at the controlling valve 401, detects the opening degree of the controlling valve 401. The opening degree detector 405 sets a controlling valve full-opening flag signal “u” to 1 when the controlling valve 401 is fully opened, and sets the controlling valve full-opening flag signal “u” to 0 when the controlling valve 401 is not fully opened. The opening degree detector 405 supplies the controlling valve full-opening flag signal “u” to a controlling apparatus 300.

The controlling apparatus 300 includes a controlling unit 620. The controlling unit 620 is a pressure controlling circuit that controls the #2 turbine bypass regulating valve 201 according to the embodiment. The controlling unit 620 switches the controlling scheme for closing the #2 turbine bypass regulating valve 201, depending on whether the controlling valve 401 is in the full open state. Before the controlling valve 401 is in the full open state, the controlling unit 620 closes the #2 turbine bypass regulating valve 201 in accordance with a predetermined time-dependent change (for example, a predetermined changing rate).

As an example thereof, before the controlling valve 401 is in the full open state, the controlling unit 620 closes the #2 turbine bypass regulating valve 201 at a predetermined valve closing rate. Concretely, for example, before the controlling valve 401 is in the full open state, the controlling unit 620 decreases a control command value by which the valve opening degree of the #2 turbine bypass regulating valve 201 is commanded, at the above predetermined valve closing rate, and controls the #2 turbine bypass regulating valve 201 such that it has a control command value indicated by the decreased control command value.

On the other hand, when the controlling valve 401 is in the full open state, the controlling unit 620 controls the #2 turbine bypass regulating valve 201, based on the pressure of the #2 drum 213 of the subsequently started power-generating plant. For more detail, the controlling unit 620 controls the #2 turbine bypass regulating valve 201 such that the pressure of the #2 drum 213 rises at a predetermined changing rate. As an example thereof, the controlling unit 620 increases the pressure setting value of the #2 turbine bypass regulating valve 201 at the above predetermined changing rate, and controls the #2 turbine bypass regulating valve 201 such that the pressure of the #2 drum 213 has the increased pressure setting value.

Here, the position of the sensor 212, which is not limited to the position in FIG. 1, may be in the interior of the #2 drum 213, or may be any position between the outlet of the #2 drum 213 and the #2 turbine bypass regulating valve 201 or #2 isolation valve. That is, the pressure of the drum is the pressure in the interior of the #2 drum 213, or the pressure at any position between the outlet of the #2 drum 213 and the #2 turbine bypass regulating valve 201 or #2 isolation valve.

An example of the concrete process of the controlling unit 620 when the controlling valve 401 is in the full open state will be explained. The controlling unit 620 acquires the pressure detected by the sensor 212. Then, the controlling unit 620 increases the pressure setting value of the #2 turbine bypass regulating valve 201 at the above predetermined changing rate, and controls the #2 turbine bypass regulating valve 201 based on the difference between the acquired pressure and the increased pressure setting value. Thereby, the pressure of the #2 drum 213 changes so as to have the pressure setting value, and therefore, the controlling unit 620 can raise the pressure of the #2 drum 213 at the predetermined changing rate.

Similarly to the controlling apparatus 310 in FIG. 5, the controlling apparatus 300 employs a digital computing scheme in which the computation is performed in a sampling period of 250 milliseconds, as an example, and in the interior, the controlling unit 620 is programmed as software. Here, in FIG. 1, for constituent elements having the same configuration and function as FIG. 5, the same reference numerals are assigned, and the explanations are omitted.

The controlling apparatus 300 includes a sampling delay device 232, a subtracter 233, a switcher 610, a sampling delay device 611, an adder 612, a NOT gate 613, an AND gate 615, a PID controller 621, a subtracter 622, and switcher 630. Thus, compared to the controlling apparatus 310 in FIG. 5, in the controlling apparatus 300 in FIG. 1, the switcher 230 is changed into the switcher 630, the subtracter 222 is changed into the subtracter 622, the PID controller 221 is changed into the PID controller 621, and the switcher 610, the sampling delay device 611, the adder 612, the NOT gate 613 and the AND gate 615 are added.

The operation of the PID controller 621 included in the controlling unit 620 is equivalent to the PID controller 221. However, there is a difference in that the SV value “c” that is the setting value of the PID controller 221 is only the fixed value of 7.0 MPa, whereas a SV value “d” that is a setting value to be selected by the action of the switcher 610 is used as that of the PID controller 621.

Next, the switcher 630 will be explained. Two signals of a MV value “j” and valve closing command value “b” of the PID controller 621 are input to the switcher 630. In the case where an output signal “p” of the AND gate 615 is 0, the switcher 630 electrically connects the output of the PID controller 621 and the #2 turbine bypass regulating valve 201. On the other hand, in the case where the output signal “p” of the AND gate 615 is 1, the switcher 630 electrically connects the output of the subtracter 233 and the #2 turbine bypass regulating valve 201. Therefore, in the case of the output signal “p” of the AND gate 615=0, the switcher 630 outputs the MV value “j” as a control command value “w” of the controlling unit 620. On the other hand, in the case of the output signal “p” of the AND gate 615=1, the switcher 630 outputs the valve closing command value “b” as the control command value “w”.

The valve closing command value “b” is the same as the valve closing command value “b” in FIG. 5, and the explanation is omitted.

In the embodiment, two signals of a fixed setting value “e” of 7.0 MPa and a variable setting value “f” described later are input to the switcher 610. In the case of the controlling valve full-opening flag signal “u”=0 (the controlling valve 401 is not fully opened), the switcher 610 selects the fixed setting value “e” (7.0 MPa) as the SV value “d” that is the output. On the other hand, in the case of the controlling valve full-opening flag signal “u”=1 (the controlling valve 401 is fully opened), the switcher 610 performs the switching so as to select the variable setting value “f” as the SV value “d”.

As the variable setting value “f”, the value resulting from adding “ΔSV” [MPa] to a one-sampling-period prior (250 milliseconds prior) SV value “d” is given by the actions of the sampling delay device 611 shown by a symbol “Z⁻¹” and the adder 612. The actions will be concretely explained along time series.

At a certain sampling period (time=0), the controlling valve 401 is in a state of an intermediate opening degree (the controlling valve full-opening flag signal “u”=0) by the preceding pressure control, and at this time, the switcher 610 selects the fixed setting value “e” of 7.0 MPa, as the SV value “d” of the PID controller 621.

Assuming that the controlling valve 401 is fully opened (the controlling valve full-opening flag signal “u”=1) at the next sampling period (time=250 milliseconds), the switcher 610 selects the variable setting value “f” as the SV value “d” of the PID controller 621. By the actions of the sampling delay device 611 and the adder 612, the variable setting value “f” is the value resulting from adding 7.0 MPa, which is the one-sampling-period prior (time=0) SV value “d”, and “ΔSV”, resulting in the variable setting value “f”=7.0 MPa+“ΔSV”. Therefore, the SV value “d” of the PID controller 621 rises from 7.0 MPa to 7.0 MPa+“ΔSV”.

Here, the controlling valve full-opening flag signal “u” indicating whether the controlling valve 401 is fully opened branches to be input to the NOT gate 613, and the NOT gate 613 outputs a signal “v” that is the inverse thereof. Two signals of the isolation valve opening degree signal “m” and the signal “v” are input to the AND gate 615. In the case where both of the isolation valve opening degree signal “m” and the signal “v” (that is, in the case where the #2 isolation valve 204 is opened and the controlling valve 401 is not fully opened) are 1, the AND gate 615 sets an output signal “p” to 1. Otherwise, the AND gate 615 sets the output signal “p” to 0.

On this occasion, the controlling valve full-opening flag signal “u”=1 results in the output signal “p” of the AND gate 615=0, and therefore, the MV value “j” that is the control command value of the PID controller 621 is supplied to the #2 turbine bypass regulating valve 201, as the control command value “w” of the controlling unit 620. Then, the #2 turbine bypass regulating valve 201 decreases the valve opening degree of the #2 turbine bypass regulating valve 201 such that the inside pressure of the #2 drum 213 (that is, the pressure of the insertion steam) rises to 7.0 MPa+“ΔSV”.

Then, at the next sampling period (time=500 milliseconds), similarly, the SV value “d”=the variable setting value “f”=7.0 MPa+2×“ΔSV” holds, and the MV value “j” of the PID controller 621 is 7.0 MPa+2×“ΔSV”. Therefore, the #2 turbine bypass regulating valve 201 further decreases the valve opening degree of the #2 turbine bypass regulating valve 201 such that the pressure of the insertion steam rises to 7.0 MPa+2×“ΔSV”.

Then, at the next sampling period (time=750 milliseconds), the SV value “d”=7.0 MPa+3×“ΔSV” holds, and at the further next sampling period (time=1000 milliseconds), the SV value “d”=7.0 MPa+4×“ΔSV” holds.

After the controlling valve 401 is fully opened in this way, the SV value “d” of the PID controller 621 rises at a changing rate of 4×“ΔSV” [MPa], for one second, that is, for four periods of the sampling period of 250 milliseconds. Then, in response to this, the valve closing of the #2 turbine bypass regulating valve 201 is operated, and the insertion steam pressure (that is, the inside pressure of the #2 drum 213) rises at the changing rate of 4×“ΔSV” [MPa]/second, similarly. By this action, the insertion steam, which was being flowed in the steam condenser, is sent to the steam header unit 505.

### Starting Method According to the Embodiment

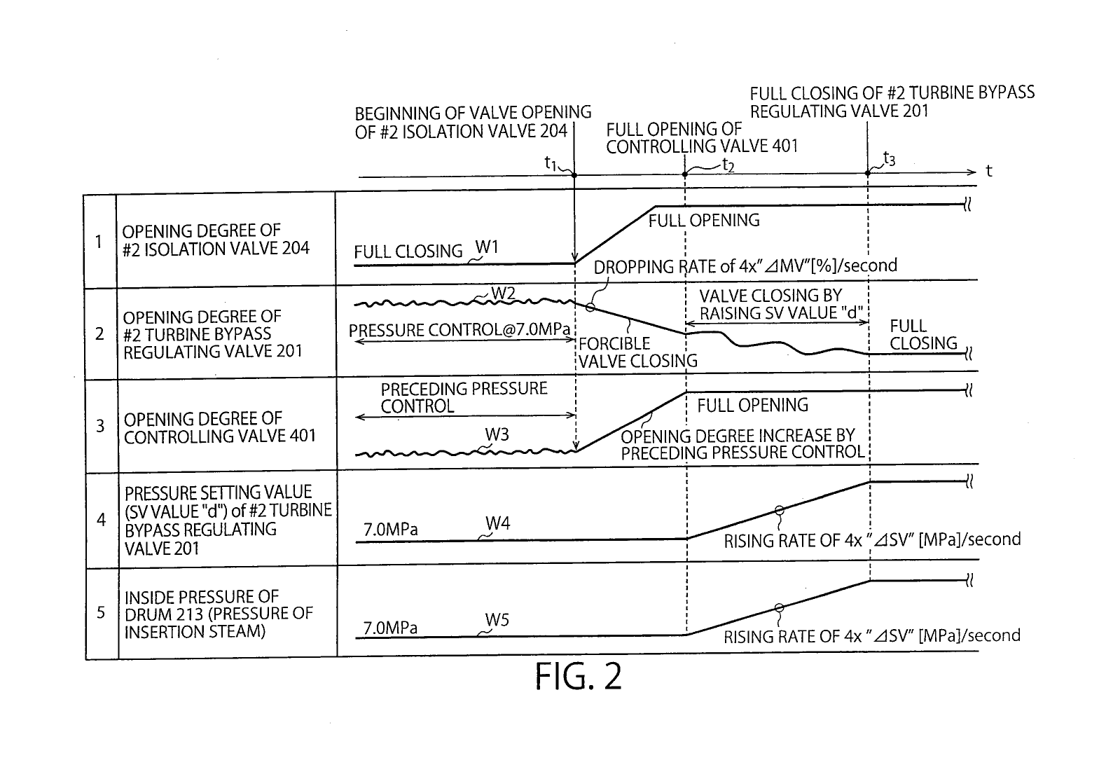

FIG. 2 is a starting chart showing a starting method for the multi-axial combined cycle power-generating plant according to the embodiment. How the controlling unit 620 acts to the whole of the starting method for the power-generating plant is shown. FIG. 2 illustrates a waveform W1 showing a temporal change in the opening degree of the #2 isolation valve 204, a waveform W2 showing the opening degree of the #2 turbine bypass regulating valve 201, a waveform W3 showing the opening degree of the controlling valve 401, a waveform W4 showing the pressure setting value (SV value “d”) of the #2 turbine bypass regulating valve 201, and a waveform W5 showing the inside pressure (the pressure of the insertion steam) of the #2 drum 213.

The initial state in FIG. 2 is the same as the starting chart in FIG. 6. The antecedent #1 unit is started, the turbine driving steam generated by the antecedent #1 unit drives the steam turbine 402, and the preceding pressure control is applied to the controlling valve 401 so that the steam header unit 505 is kept at 7.0 MPa. However, there is a difference in that the opening degree of the controlling valve 401 is initially opened at a larger opening degree than FIG. 6.

On this occasion, the #2 isolation valve 204 is fully closed, resulting in the output signal “p” of the AND gate 615=0. Further, the controlling valve 401 is opened, but is not fully opened, resulting in the controlling valve full-opening flag signal “u”=0. Therefore, in the subsequent #2 unit, the feedback pressure control by the SV value “d” of 7.0 MPa is performed to the #2 turbine bypass regulating valve 201, and the insertion steam is kept at a pressure of 7.0 MPa.

After the starting of the #2 gas turbine 210, the pressure and temperature of the insertion steam increase and rise as time passes. When they get to be suitable values for starting, the valve opening operation of the #2 isolation valve 204 is gradually performed, the “linking” of the #2 unit to the #1 unit and the steam turbine 402 is performed, and the “insertion” begins.

When the valve opening of the #2 isolation valve 204 begins, the output signal “p” of the AND gate 615 gets to be 1, and the control command value “w” of the controlling unit 620 is switched to the valve closing command value “b”. Thereby, the controlling unit 620 performs a forcible valve closing in which the #2 turbine bypass regulating valve 201 is closed at a predetermined changing rate (4×“ΔMV”%/second). As a result, the insertion steam from the #2 unit, which was being flowed in the steam condenser until then, is sent to the steam header unit 505, and this sending raises the pressure of the steam header unit 505 to 7.0 MPa or more (microscopically speaking).

In the action of the preceding pressure control of the controlling valve 401, the pressure rise of the steam header unit 505 is detected, and the opening degree of the controlling valve 401 is increased. In other words, the steam turbine 402 absorbs the insertion steam, and thereby, the pressure falls. Then, the steam header unit 505 is restored to the pressure of 7.0 MPa. Such a procedure results in the “insertion” of the insertion steam from the #2 unit to the turbine driving steam. The starting method and procedure so far is the same as the starting method according to the comparative example.

In the following, a coping method according to the embodiment with the second problem, which stabilizes the operation of the power-generating plant in the case where the controlling valve 401 is fully opened before the #2 turbine bypass regulating valve 201 is fully closed, in a process of the successive insertion of the insertion steam from the #2 unit, will be explained.

The full opening of the controlling valve 401 results in the output signal “p” of the AND gate 615=0. Then, the control command value “w” of the controlling unit 620 is switched to the MV value “j”, and the PID controller 621 performs the feedback pressure control to the #2 turbine bypass regulating valve 201, again. For the SV value “d” that is the setting value thereof, the switcher 610 switches the SV value “d” to the variable setting value “f”, because of the controlling valve full-opening flag signal “u”=1. Therefore, as shown by the waveform W4 at times “t₂” to “t₃” in FIG. 2, the SV value “d” rises at the predetermined changing rate (4×“ΔSV” [MPa]/second), as described above.

As a result, the #2 turbine bypass regulating valve 201 is closed such that the pressure of the insertion steam rises at the changing rate of 4×“ΔSV” [MPa]/second, and the insertion steam is sent to the steam header unit 505. Incidentally, the valve closing rate of the #2 turbine bypass regulating valve 201 at this time does not have a uniform ramp shape, as shown by the waveform W2 at “t₂” to “t₃” in FIG. 2.

As shown by the waveform W5 at times “t₂” to “t₃” in FIG. 2, until the #2 turbine bypass regulating valve 201 is fully closed in this way, the pressure of the insertion steam (as well as the pressure of the steam header unit 505, the inside pressure of the #1 drum 113 and the inside pressure of the #2 drum 213) rises with the changing rate of 4×“ΔSV” [MPa]/second kept, and therewith, the “insertion” in the turbine driving steam is performed.

When the #2 turbine bypass regulating valve 201 is fully closed, the whole amount of the insertion steam joins the turbine driving steam, and the steam turbine 402 is driven. Thereafter, the load-up is performed such that the #1 gas turbine 110 and the #2 gas turbine 210 reach 100% of the rated output.

### Selection of “ΔSV”

In the embodiment, the predetermined changing rate (4×“ΔSV” [MPa]/second) at which the pressure setting value of the #2 turbine bypass regulating valve 201 rises may be set to a proper value that does not cause water level fluctuations in the drums by the inside pressure rises of the #1 drum 113 and #2 drum 213 due to it.

As an example of the method for selecting the “proper value that does not cause water level fluctuations”, an approach of performing the selection in accordance with an operation record in a sliding pressure region will be explained below. Generally, in a cold starting, in which the starting is performed in a state in which the preservation is performed while the member metal temperature of the steam turbine 402 is a low temperature, as shown by the starting chart in FIG. 6, the controlling valve 401 is not fully opened before the #2 turbine bypass regulating valve 201 is fully closed, in the process of the “insertion” of the insertion steam from the #2 unit.

That is, in the cold starting, it is unnecessary to raise the pressure setting value of the #2 turbine bypass regulating valve 201 at a predetermined changing rate, as described above. Then, after the #2 turbine bypass regulating valve 201 is fully closed and the whole amount of the insertion steam joins the turbine driving steam, the output rises of the #1 gas turbine 110 and #2 gas turbine 210 are performed. In response to a large amount of generated steam from the #1/#2 units associated with it, the preceding pressure control increases the opening degree of the controlling valve 401, and the controlling valve 401 is fully opened before the #1 gas turbine 110 and the #2 gas turbine 210 reach 100% of the rated output.

Even after the controlling valve 401 is fully opened, the output rises are continuously performed such that the #1 gas turbine 110 and the #2 gas turbine 210 reach 100% of the rated output. As for the generated steam from the #1/#2 units associated with it, the pressure of the steam header unit 505 (and the inside pressures of the #1 drum 113 and #2 drum 213 that are directly linked with this) rises because the controlling valve 401 is fully opened. A region in which the operation is performed while being accompanied by such a pressure rise is called a sliding pressure region. Generally, the rising rate of the inside pressure of the drum generated in the sliding pressure region is relatively slow, and this slow pressure changing rate does not cause the drum water level fluctuation.

Nowadays, the inside pressure rising rate of the drum in the sliding pressure region of the latest combined cycle power-generating plant, which varies with the properties and design conditions of the gas turbine and heat recovering steam generator, is about 0.2 MPa/minute to 0.5 MPa/minute, for example.

For example, suppose that the cold starting is performed in a trial operation of the multi-axial combined cycle power-generating plant to which the embodiment is applied, and as a result, historical data in which the inside pressure rising rate in the sliding pressure region is 0.36 MPa/minute is obtained. Because of 0.36 MPa/minute=0.006 MPa/second, by solving “0.006 MPa/second=4×ΔSV [MPa]/second”, “ΔSV”=0.00015 [MPa] is set as a parameter (constant) in the software. Thus, the predetermined changing rate for raising the pressure setting value of the #2 turbine bypass regulating valve 201 may be set depending on the pressure value of the #2 drum 213 in the sliding pressure region operation in which the operation is performed while being accompanied by the pressure rise of the steam header unit 505 and the pressure rises of the #1 drum 113 and #2 drum 213 that are directly linked with this. Thereby, it is possible to select a proper value that does not cause the drum water level fluctuations.

The drum water level fluctuation arises, as the mechanism, from the so-called shrinking phenomenon in which air bubbles (voids) in an evaporator burst due to increased pressure and the volume in the evaporator sharply decreases. Generally, it is very difficult to calculate a proper value that does not cause the water level fluctuation, by a theoretical calculation or a simulation analysis, because various factors such as the design condition and operation condition of the heat recovering steam generator are related. However, by focusing attention on the operation in the sliding pressure region, it is possible to determine a secure and proper value.

### Effect of the Embodiment

Next, the effect of the embodiment will be explained. Before the controlling valve 401 is in the full open state, the controlling unit 620 according to the embodiment closes the turbine bypass regulating valve, in accordance with a predetermined time-dependent change (for example, a predetermined changing rate). On the other hand, when the controlling valve 401 is in the full open state, the controlling unit 620 controls the #2 turbine bypass regulating valve 201, based on the pressure of the #2 drum 213 of the subsequently started power-generating plant.

After the controlling valve 401 is in the full open state, the preceding pressure control performed until then stops functionally. Therefore, even when the controlling unit 620 controls the #2 turbine bypass regulating valve 201 based on the pressure of the drum 213, the pressure controls of two lines of the controlling valve 401 and the #2 turbine bypass regulating valve 201 do not result in the above-pointed parallelizing, and it is possible to avoid the occurrence of the interference of the pressure controls. Furthermore, the turbine bypass regulating valve is controlled based on the pressure of the drum 213, and thereby, it is possible to suppress the water level fluctuation in the drum 213. Therefore, even after the controlling valve 401 is fully opened before the turbine bypass regulating valve is fully closed, it is possible to perform the insertion of the insertion steam while securing the stable operation of the #1 unit and the #2 unit.

Before the controlling valve 410 is in the full open state, the controlling unit 620 closes the #2 turbine bypass regulating valve 201 at a predetermined valve closing rate. On the other hand, when the controlling valve 401 is in the full open state, the controlling unit 620 controls the #2 turbine bypass regulating valve 201 such that the pressure of the #2 drum 213 of the subsequently started power-generating plant rises at a predetermined changing rate.

Thereby, as shown by the waveform W5 in FIG. 2, the inside pressure of the drum 213 rises at the predetermined changing rate, and therefore, it is possible to suppress the water level fluctuation of the drum 213. Therefore, even after the controlling valve 401 is fully opened before the turbine bypass regulating valve is fully closed, it is possible to perform the insertion of the insertion steam while securing the stable operation of the #1 unit and the #2 unit.

Furthermore, the pressure of the insertion steam, that is, the inside pressures of the #1 drum 113 and the #2 drum 213, rises in pressure at a changing rate of 4×“ΔSV” [MPa]/second, and therewith, the “insertion” is performed. This changing rate is determined by “ΔSV” that is given as a parameter (constant) in the software to be executed by the controlling unit 620, and this value can be arbitrarily selected by a designer.

The starting according to the embodiment and the starting shown by the starting chart in FIG. 7 according to the comparative example will be compared. If a starting method in which, as shown in FIG. 7, even after the controlling valve 401 is fully opened, the forcible valve closing of the #2 turbine bypass regulating valve 201 is performed and the insertion steam is inserted is adopted, there are two problem as follows.

As the first problem, although the valve closing rate of the #2 turbine bypass regulating valve 201 is a uniform changing rate of 4×“ΔMV” [%]/second, the inside pressures of the #1 drum 113 and the #2 drum 213 do not uniformly rise just because the valve is uniformly closed, and the changing rates of the drum inside pressures are random. In the worst case, a sudden pressure rise results in a drastic drop in the drum water level. Then, the heat recovering steam generator is stopped, and even after the controlling valve 401 is fully opened, it is impossible to secure the stable operation of the #1 unit and the #2 unit.

As the second problem, even when it is found through the operation in the sliding pressure region that the proper pressure rising rate that does not cause the drum water level fluctuations is 0.36 MPa/minute, it is difficult to evaluate and calculate what value of the valve closing rate of the #2 turbine bypass regulating valve 201 actualizes the pressure rise of 0.36 MPa/minute. The calculation under various conditions of the steam pressure, temperature and flow rate is virtually impossible.

In contrast, as described above, in the embodiment, a designer can set the “ΔSV” on the software to be executed by the controlling unit 620, to 0.00015 [MPa], for example. Further, by such a setting, the changing rates of the inside pressure rises of the #1 drum 113 and the #2 drum 213 can be controlled to 0.36 MPa/minute, which does not cause the drum water level fluctuations. Thereby, the above-described second problem is solved. Further, since it does not cause the drum water level fluctuations, even after the controlling valve 401 is fully opened before the turbine bypass regulating valve is fully closed, it is possible to perform the insertion of the insertion steam while securing the stable operation of the #1 unit and the #2 unit. Thereby, the above-described first problem is also solved.

Furthermore, a third effect in the embodiment is an effect against the second problem. That is, also in the case where the insertion steam of the #2 unit is inserted in a state in which the controlling valve 401 is fully opened with the 1-1-1 operation performed, the embodiment can be applied. In this case, when the #2 isolation valve 204 is opened, the controlling valve 401 is fully opened already. Therefore, because of the output signal “p” of the AND gate 615=0, the valve closing operation of the #2 turbine bypass regulating valve 201 by the forcible valve closing is not performed. The #2 turbine bypass regulating valve 201 can insert the insertion steam, by the feedback pressure control with the SV value “d” having a rising rate of 0.36 MPa/minute.

Therefore, without being forced to perform the conventional inconvenient operation, in which the output fall of the #1 unit operating at 100% of the rated output is performed before the insertion of the #2 unit, it is possible to insert the insertion steam of the #2 unit, while the #1 unit keeps 100% of the rated output.

### First Modification of the Embodiment

The above embodiment is applied to two turbine bypass valves, but the starting procedure according to the embodiment can be applied also to a 3-3-1 multi-axial combined cycle power-generating plant that is configured by three gas turbines and three heat recovering steam generators (a #1 unit, a #2 unit and a #3 unit).

For example, when the insertion steam of the #3 unit is inserted in a state in which the #1 unit and the #2 unit are linked, the starting procedure according to the embodiment can be applied to a pressure controlling circuit of a #3 turbine bypass regulating valve. Here, in the operation state in which the #1 unit and the #2 unit are linked, a large amount of turbine driving steam generated by both units is supplied to the controlling valve, and therefore, the controlling valve is opened at a relatively large opening degree, or in some cases, has a strong tendency to be fully opened.

As easily understood, by repeating this starting procedure, the application to an N-N-1 multi-axial combined cycle power-generating pant configured by gas turbines and heat recovering steam generators whose numbers are N (N is a natural number) is also possible.

### Second Modification of the Embodiment

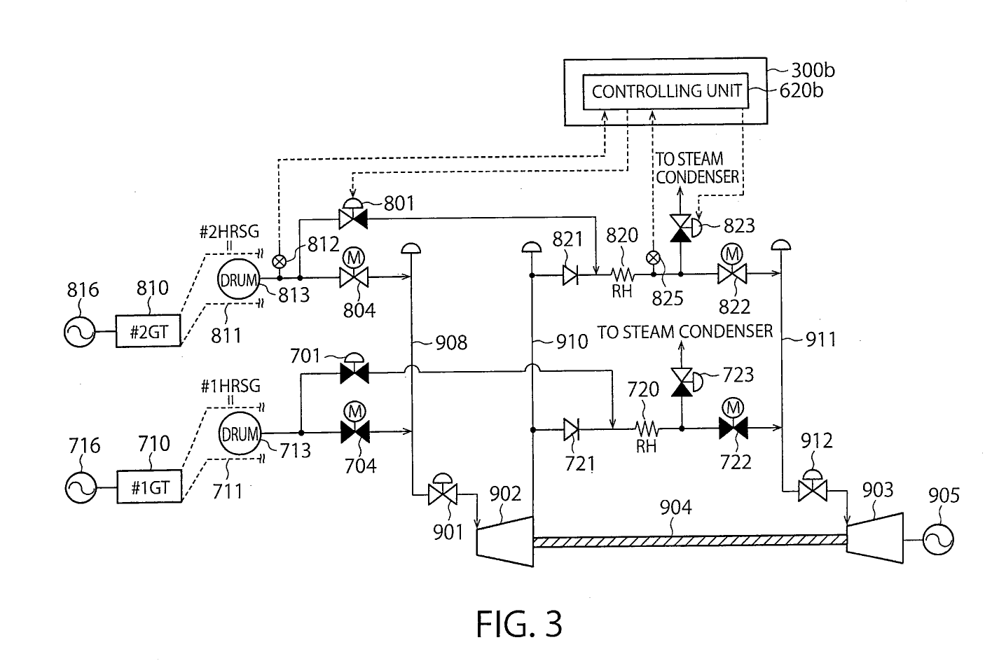

FIG. 3 is a schematic configuration diagram showing a second modification of the multi-axial combined cycle power-generating plant and the configuration of a controlling apparatus 300b. The controlling apparatus 300b according to the second modification includes a controlling unit 620b.

As for the steam turbine, a high-pressure steam turbine (first steam turbine) 902 and a low-pressure steam turbine (second steam turbine) 903 are provided on an identical axle 904, and drive a power generator 905 together. Here, the low-pressure steam turbine 903 has a lower pressure than the high-pressure steam turbine 902. The high-pressure steam generated from a #1 high-pressure drum 713 and a #2 high-pressure drum 813 is sent to a high-pressure steam header unit 908, and passes through a controlling valve 901 to drive the high-pressure steam turbine 902.

The characteristic of the modification is to use reheated steam. That is, the steam after driving the high-pressure steam turbine 902 is exhausted, and is sent to a low-pressure reheat header unit 910. The steam branches from the low-pressure reheat header unit 910, and is flowed in a #1 reheater 720 incorporated in a #1 heat recovering steam generator 711 and a #2 reheater 820 incorporated in a #2 heat recovering steam generator 811. The flowed steam is superheated by the #1 reheater 720 and the #2 reheater 820, to become high-temperature reheated steam. The high-temperature reheated steam is sent to a high-pressure reheated steam header unit 911, and passes through an intercept valve 912 to drive the low-pressure steam turbine 903.

Further, the line configuration of the turbine bypass regulating valve involves a scheme called a cascade bypass. A #1 high-pressure turbine bypass regulating valve 701 and a #2 high-pressure turbine bypass regulating valve 801 are connected with an inlet part of the #1 reheater 720 and an inlet part of the #2 reheater 820, respectively. An outlet part of the #1 reheater 720 and an outlet part of the #2 reheater 820 are connected with a #1 low-pressure turbine bypass regulating valve 723 and a #2 low-pressure turbine bypass regulating valve (second turbine bypass regulating valve) 823, respectively, and are connected with steam condensers not shown in the figure.

In the starting of the multi-axial combined cycle power-generating plant according to the modification, which conforms to the starting procedure of the configuration example in FIG. 1, the #1 unit is antecedently started, and in a state in which the high-pressure steam turbine 902 and the low-pressure steam turbine 903 are driven, the “insertion” of the insertion steam generated by the subsequent #2 unit is performed.

Shortly after the starting, the insertion steam, which has an insufficient pressure and temperature, cannot be used as the insertion steam for starting, and both valves of a #2 high-pressure isolation valve 804 and a #2 reheat isolation valve 822 are fully closed. Therefore, the operation is performed such that the insertion steam passes through the #2 high-pressure turbine bypass regulating valve 801, the #2 reheater 820 and the #2 low-pressure turbine bypass regulating valve 823, in order, and is released to the steam condenser.

Thereafter, when the insertion steam reaches a necessary pressure and temperature, the “insertion” begins. The “insertion” to the high-pressure steam turbine 902 begins by the valve opening of the #2 high-pressure isolation valve 804. A sensor 812 detects the pressure at the outlet of the #2 drum 813, and outputs a signal indicating the detected pressure value, to the controlling unit 620b of the controlling apparatus 300b. The starting and control of the controlling valve 901 and #2 high-pressure turbine bypass regulating valve 801 are the same as those of the controlling valve and the #2 turbine bypass regulating valve 201, and the explanation is omitted.

In parallel to the “insertion” of the high-pressure steam turbine 902, simultaneously, the “insertion” to the low-pressure steam turbine 903 proceeds. This begins by the valve opening of the #2 reheat isolation valve 822.

Here, a sensor 825 detects the pressure at the outlet of the #2 reheater 820, and outputs a signal indicating the detected pressure value, to the controlling unit 620b of the controlling apparatus 300b. The controlling unit 620b controls the #2 low-pressure turbine bypass regulating valve 823 such that the reheated steam pressure at the outlet of the #2 reheater 820 is kept at a predetermined pressure value. This is a configuration similar to the pressure control in the above-described embodiment, in which the #2 turbine bypass regulating valve 201 keeps the generated steam at the outlet of the #2 drum 213, at the predetermined pressure value (7.0 MPa).

Further, a controlling circuit not shown in the figure executes the preceding pressure control of the intercept valve 912 such that the high-temperature reheated steam pressure of the high-pressure reheated steam header unit 911 is kept at a predetermined value. By the preceding pressure control of the intercept valve 912, the steam amount to be flowed in the low-pressure steam turbine 903 is controlled.

This is similar to the preceding pressure control of the controlling valve 401, in which the steam amount to be flowed in the steam turbine 402 is controlled such that the steam pressure of the steam header unit 505 is kept at the predetermined value (7.0 MPa).

Therefore, before the intercept valve 912 is in the full open, the controlling unit 620b performs the forcible valve closing of the #2 low-pressure turbine bypass regulating valve 823, for the “insertion” to the low-pressure steam turbine 903. On that occasion, the controlling unit 620b closes the second #2 low-pressure turbine bypass regulating valve at a predetermined second valve closing rate. Concretely, for example, a control command value by which the valve opening degree of the #2 low-pressure turbine bypass regulating valve 823 is commanded is decreased at the predetermined second valve closing rate, and the #2 low-pressure turbine bypass regulating valve 823 is controlled so as to have a valve opening degree that is indicated by the decreased control command value.

Then, after the intercept valve 912 is fully opened in the process, the controlling unit 620b controls the #2 low-pressure turbine bypass regulating valve such that the pressure at the outlet of the reheater 820 rises at a predetermined changing rate. Concretely, for example, the controlling unit 620b performs the pressure control of the #2 low-pressure turbine bypass regulating valve 823, using the PID controller, and raises the setting value (SV value) for the pressure control, at the predetermined changing rate.

Thus, in the combined cycle power-generating plant according to the second modification, the steam turbine includes the high-pressure steam turbine 902, and the low-pressure steam turbine 903 with a lower pressure than the high-pressure steam turbine 902. After passing through the controlling valve 901 and driving the high-pressure steam turbine 902, the turbine driving steam is exhausted, and is superheated again by the reheater 820 incorporated in the heat recovering steam generator, to become the reheated steam.

The whole of the reheated steam from the reheater 720 of at least one power-generating plant antecedently started, as the low-pressure turbine driving steam, passes through the intercept valve 912, and drives the low-pressure steam turbine 903. The reheated steam from the reheater 820 of one power-generating plant subsequently started passes through the second turbine bypass regulating valve 823 that is opened such that the pressure of the reheated steam is kept at the predetermined pressure setting value, and is sent to other than the low-pressure steam turbine 903. In this state, the combined cycle power-generating plant according the second modification performs the starting, by closing the second turbine bypass regulating valve 823, and thereby, inserting the reheated steam of the subsequent starting, into the upstream part of the intercept valve 912, as the insertion steam to the low-pressure turbine driving steam.

Before the intercept valve 912 is in the full open state, the controlling unit 620b closes the second #2 low-pressure turbine bypass regulating valve at the predetermined valve closing rate. On the other hand, when the intercept valve 912 is in the full open, the controlling unit 620b controls the #2 low-pressure turbine bypass regulating valve such that the pressure at the outlet of the reheater 820 rises at the predetermined changing rate.

### Third Modification of the Embodiment

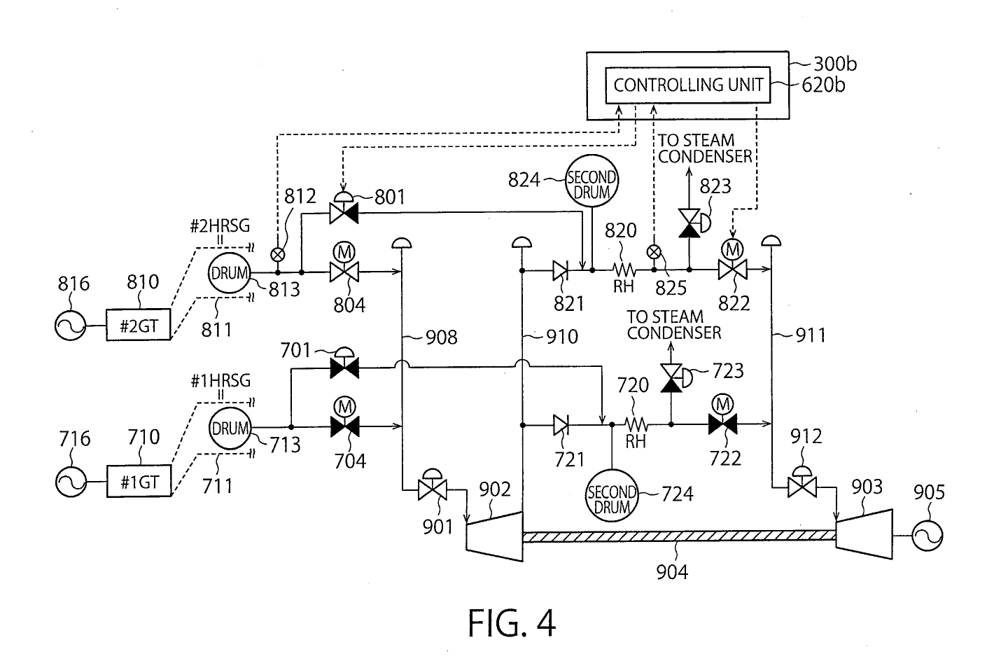

Next, FIG. 4 is a schematic configuration diagram showing a third modification of the multi-axial combined cycle power-generating plant and the configuration of a controlling apparatus 300b. In the configuration of a multi-axial combined cycle power-generating plant in FIG. 4, a #1 second drum 724 and a #2 second drum 824 are added, compared to the configuration of the multi-axial combined cycle power-generating plant in FIG. 3. The configuration of a controlling apparatus 300b in FIG. 4 is the same as the configuration of the controlling apparatus 300b in FIG. 3, and the explanation is omitted.

Other than the #1 drum 713 and the #2 drum 813, the #1 heat recovering steam generator 711 and the #2 heat recovering steam generator 811 include the #1 second drum 724 and the #2 second drum 824, respectively. The #1 second drum 724 is connected such that the steam generated by the #1 second drum 724 is sent to the inlet part of the #1 reheater 720. Further, the #2 second drum 824 is connected such that the steam generated by the #2 second drum 824 is sent to the inlet part of the #2 reheater 820.

In this configuration, there is a fear that a sudden pressure rise of the reheated steam causes drastic fluctuations in the water levels of the #1 second drum 724 and the #2 second drum 824. Hence, a second changing rate at which the setting value (SV value) for the pressure control of the #2 low-pressure turbine bypass regulating valve 823 rises is set such that the water level fluctuations in the #1 second drum 724 and #2 second drum 824 associated with the inside pressure rises of the #1 second drum 724 and #2 second drum 824 by it fall within a predetermined range.

Here, the second changing rate at which the setting value (SV value) for the pressure control of the #2 low-pressure turbine bypass regulating valve 823 rises may be set depending on the pressure value of the #1 second drum 724 or #2 second drum 824 in a sliding pressure region operation in which the operation is performed while being accompanied by the pressure rise of the high-pressure reheated steam header unit 911 and the pressure rise of the #1 second drum 724 or #2 second drum 824.

Here, in the above-described explanation, the example in which the most common PID controller is used as a controller for the pressure control has been described. However, it is known that an LQR, a GPC and the like have a similar feedback control function, and the present invention can be applied even when these controllers having the equivalent function are used.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A controlling apparatus for a combined cycle power-generating plant having a plurality of power-generating plants, each of the power-generating plants comprising: a power generator; a gas turbine that is connected with the power generator; and an heat recovering steam generator that recovers heat of exhaust gas from the gas turbine and generates steam from an incorporated drum, the combined cycle power-generating plant being started when generated steam from at least one power-generating plant antecedently started passes through a controlling valve and is supplied to a steam turbine, as turbine driving steam, and generated steam from one power-generating plant subsequently started is inserted into an upstream part of the controlling valve, as insertion steam to the turbine driving steam, depending on an opening degree of a turbine bypass regulating valve that is connected with the power-generating plant subsequently started,
wherein the controlling apparatus comprises a controlling unit that controls the turbine bypass regulating valve,
the controlling unit closes the turbine bypass regulating valve in accordance with a predetermined time-dependent change, before the controlling valve is in a full open state, and
the controlling unit controls the turbine bypass regulating valve based on a pressure of the drum of the power-generating plant subsequently started, when the controlling valve is in the full open state.

2. The controlling apparatus according to claim 1,
wherein the controlling unit closes the turbine bypass regulating valve at a predetermined valve closing rate, before the controlling valve is in the full open state, and
the controlling unit controls the turbine bypass regulating valve such that the pressure of the drum of the power-generating plant subsequently started rises at a predetermined changing rate, when the controlling valve is in the full open state.

3. The controlling apparatus according to claim 2,
wherein the controlling unit decreases, at the predetermined valve closing rate, a control command value by which a valve opening degree of the turbine bypass regulating valve is commanded, and controls the turbine bypass regulating valve such that the turbine bypass regulating valve has a valve opening degree that is indicated by the decreased control command value, before the controlling valve is in the full open state, and
the controlling unit increases a pressure setting value of the turbine bypass regulating valve at the predetermined changing rate, and controls the turbine bypass regulating valve such that the pressure of the drum of the power-generating plant subsequently started has the increased pressure setting value, when the controlling valve is in the full open state.

4. The controlling apparatus according to claim 3,
wherein the changing rate is set such that a water level fluctuation in the drum associated with a pressure rise of the drum falls within a predetermined range.

5. The controlling apparatus according to claim 3,
wherein the changing rate is set depending on a pressure value of the drum in a sliding pressure region operation in which an operation is performed while being accompanied by a pressure rise of the drum.

6. The controlling apparatus according to claim 1,
wherein the steam turbine comprises a first steam turbine, and a second steam turbine with a lower pressure than the first steam turbine,
the turbine driving steam is exhausted after passing through a controlling valve and driving the first steam turbine, and then, is superheated again by a reheater incorporated in an heat recovering steam generator, to become reheated steam,
reheated steam from a first reheater of the at least one power-generating plant antecedently started passes through an intercept valve and is supplied to the second steam turbine, as low-pressure turbine driving steam,
reheated steam from a second reheater of the one power-generating plant subsequently started is inserted into an upstream part of the intercept valve, as insertion steam to the low-pressure turbine driving steam, depending on an opening degree of a second turbine bypass regulating valve,
the controlling unit closes the second turbine bypass regulating valve at a predetermined second valve closing rate, before the intercept valve is in a full open state, and
the controlling unit controls the second turbine bypass regulating valve such that a pressure at an outlet of the reheater rises at a predetermined second changing rate, when the intercept valve is in the full open state.

7. The controlling apparatus according to claim 6,
wherein the controlling unit
decreases, at the predetermined second valve closing rate, a control command value by which a valve opening degree of the second turbine bypass regulating valve is commanded, and controls the second turbine bypass regulating valve such that the second turbine bypass regulating valve has a valve opening degree that is indicated by the decreased control command value, before the intercept valve is in the full open state, and
increases, at the predetermined second changing rate, a pressure setting value of the second turbine bypass regulating valve, and controls the second turbine bypass regulating valve such that the pressure of the drum has the increased pressure setting value, when the intercept valve is in the full open state.

8. The controlling apparatus according to claim 7,
wherein in the combined cycle power-generating plant, a first drum incorporated in the heat recovering steam generator of the at least one power-generating plant antecedently started is connected with an inlet of a first reheater, and a second drum incorporated in the heat recovering steam generator of the one power-generating plant subsequently started is connected with an inlet of a second reheater, and
the second changing rate is set such that a water level fluctuation in the first drum associated with a pressure rise in the first drum and a water level fluctuation in the second drum associated with a pressure rise in the second drum fall within a predetermined range.

9. The controlling apparatus according to claim 7,
wherein in the combined cycle power-generating plant, a first drum incorporated in the heat recovering steam generator of the at least one power-generating plant antecedently started is connected with an inlet of a first reheater, and a second drum incorporated in the heat recovering steam generator of the one power-generating plant subsequently started is connected with an inlet of a second reheater, and
the second changing rate is set depending on a pressure value of the first drum or second drum in a sliding pressure region operation in which an operation is performed while being accompanied by a pressure rise of the first drum or second drum.

10. A starting method for a combined cycle power-generating plant having a plurality of power-generating plants, each of the power-generating plants comprising: a power generator; a gas turbine that is connected with the power generator; and an heat recovering steam generator that recovers heat of exhaust gas from the gas turbine and generates steam from an incorporated drum, the combined cycle power-generating plant being started when generated steam from at least one power-generating plant antecedently started passes through a controlling valve and is supplied to a steam turbine, as turbine driving steam, and generated steam from one power-generating plant subsequently started is inserted into an upstream part of the controlling valve, as insertion steam to the turbine driving steam, depending on an opening degree of a turbine bypass regulating valve that is connected with the power-generating plant subsequently started,
the starting method comprising:
closing the turbine bypass regulating valve in accordance with a predetermined time-dependent change, before the controlling valve is in a full open state; and
controlling the turbine bypass regulating valve based on a pressure of the drum of the power-generating plant subsequently started, when the controlling valve is in the full open state.
